(19) United States
(12) Patent Application Publication
(10) Pub. No.: US 2017/0191851 A1
(43) Pub. Date: Jul. 6, 2017

(54) POSITION SENSING SYSTEM

(71) Applicant: MTS Sensor Technologie GmbH & Co. KG, Lüdencheid (DE)

(72) Inventors: Andreas Hill, Essen (DE); Constantin Timm, Hattingen (DE); Rene Pekkola, Darmstadt (DE)

(21) Appl. No.: 15/380,355

(22) Filed: Dec. 15, 2016

Related U.S. Application Data
(60) Provisional application No. 62/267,694, filed on Dec. 15, 2015.

(51) Int. Cl. G01D 5/14

(52) U.S. Cl. CPC G01D 5/14

(57) ABSTRACT

Embodiments of the present disclosure include methods and apparatuses for identifying a location of a position encoding magnet. Embodiments can include detecting, by a set of sensing elements, different field components of a magnetic field of the position encoding magnet. The embodiments can also include generating, with data processing circuitry, signals associated with the set of sensing elements. The generated signals can include the different field components. The embodiments can also include determining with the data processing circuitry a location of the position encoding magnet according to the generated signals, using a calculation to generate a multicomponent-based signal representative of the different field components.

### CROSS-REFERENCE TO RELATED APPLICATION

The present application is based on and claims the benefit of U.S. provisional patent application Ser. No. 62/267,694, filed Dec. 15, 2015, the content of which is hereby incorporated by reference in its entirety.

### FIELD

Embodiments of the present disclosure are directed to a position sensor system for identifying a location of a position encoding magnet.

### BACKGROUND

The discussion below is merely provided for general background information and is not intended to be used as an aid in determining the scope of the claimed subject matter.

The reed switch is an electrical switch operated by an applied magnetic field. It usually includes a pair of contacts on ferrous metal reeds in an envelope (such as a hermetically sealed glass envelope). The contacts may be normally open, closing when a magnetic field is present, or normally closed and opening when a magnetic field is applied.

A Hall effect sensor is a device that varies its output signal, such as output voltage, in response to a magnetic field. Hall effect sensors are commonly used for proximity switching, positioning, and speed detection. With a known magnetic field, a respective magnet's distance from the Hall plate can be determined. Using groups of Hall effect sensors, the position of the magnet can be deduced. A Hall sensor can be combined with circuitry that allows the device to act in a digital (on/off) mode, and may be called a switch in this configuration. This is commonly seen in industrial applications, such as applications for sensing pneumatic cylinders.

As mentioned, a Hall effect sensor may operate as an electronic switch. Usually, such a switch costs less than a mechanical switch or a reed switch and can be more reliable. Also, in the case of a linear sensor using magnetic field strength measurements, a Hall effect sensor can measure a wide range of magnetic fields, and it can measure either North or South pole magnetic fields. However, using a set of Hall effect sensors as a linear sensor can provide lower accuracy than other types of sensors. For example, fluxgate magnetometers or magnetoresistance-based sensors are known to be more accurate in some instances. Moreover, Hall effect sensors can drift, which may require compensation.

With reed switch or Hall effect sensor apparatuses used as a linear sensor, extrapolation may be required as these apparatuses are triggered at certain positions by threshold detectors. Between two trigger positions the position information usually has to be interpolated. Also, small movements back and forth usually cannot be detected reliably. In such apparatuses, often a processing unit, such as a field-programmable gate array (FPGA), a complex programmable logic device (CPLD), an application-specific integrated circuit (ASIC), a micro controller (μC) or the like, perpetually interrogates the sensing elements available and constantly scans for output signals amongst all the sensing elements. The cycle time for each scan can limit the magnet's velocity and can also reduce the accuracy where the velocity cannot be strictly controlled.

Further, methods associated with such apparatuses usually use only one field component of the magnetic field of the position magnet (or the encoder). These methods have the disadvantage of being more susceptible to temperature and magnet degradation. They also appear to be less versatile regarding the usage of different kinds of magnets or more than one magnet is needed for improved position sensing.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the Background.

Embodiments of the present disclosure include methods and apparatuses for identifying a location of a position encoding magnet.

In some exemplary embodiments, the methods include detecting, by a set of sensing elements, different field components of a magnetic field of the position encoding magnet. The methods can also include generating, with data processing circuitry, signals associated with the set of sensing elements. The generated signals can include the different field components. The methods can also include determining with the data processing circuitry a location of the position encoding magnet according to the generated signals, using a calculation to generate a multicomponent-based signal representative of the different field components.

The using of the calculation to generate the multicomponent-based signal representative of the different field components can occur for each sensing element of the set individually.

The determining of the location of the position encoding magnet can further include generating a vector field representative of the magnetic field, according to the generated signals, and determining the location of the position encoding magnet according to the vector field. The determining of the location of the position encoding magnet can also include dividing each point of the vector field into vector components corresponding to the different field components, and determining the location of the position encoding magnet according to the vector components.

The determining of the location of the position encoding magnet according to the generated signals can also use an arctangent calculation to generate the multicomponent-based signal representative of the different field components. The determining of the location of the position encoding magnet according to the generated signals can also include aggregating the multicomponent-based signals of the set of sensing elements into one signal, and may include linearizing the one aggregated signal to provide the location of the position encoding magnet.

The different field components of the magnetic field can include differently orientated components. The different field components can include an axially oriented Z-component and a radially oriented X-component.

Each sensing element of the set of sensing elements can be multidimensional such that it can sense the different field components of the magnetic field. Also, each sensing element of the set can include either a Hall effect sensor, a magneto-resistive based sensor, a reed switch, or a fluxgate magnetometer. Also, the set of sensing elements can include sensing elements in series. In such a case, each respective magnetic field sensing range of each in series sensing element of the set can overlap with at least one respective magnetic field sensing range of an immediate neighboring sensing element in the set, such that extrapolation is not required to determine the location of the position encoding magnet

The methods can also include deactivating output communications from one or more sensing elements of the set when the magnetic field is not sensed within the magnetic field sensing range of the given sensing element, by limiting or shutting off power to the one or more sensing elements. And, the methods can also include activating output communications from one or more sensing elements of the set when the magnetic field is sensed within the magnetic field sensing range of the one or more sensing elements.

In some exemplary embodiments, the apparatuses include: a position encoding magnet; a set of magnetic sensing devices, and data processing circuitry. Each of the magnetic sensing devices of the set can be configured to vary its output signal in response to a magnetic field propagated by the position encoding magnet. The data processing circuitry can be configured to determine and output a location of the position encoding magnet, according to signals generated from the set of magnetic sensing devices. The generated signals can include signals indicative of different field components of the magnetic field of the position encoding magnet. Also, a calculation is used to create a multicomponent-based signal representative of the different field components based on the generated signals. In some embodiments, an arctangent calculation is used to create the multicomponent-based signal representative of the different field components based on the generated signals.

Also, the multicomponent-based signals of the set of sensing elements can be aggregated into one signal. In some cases, the one aggregated signal can be linearized to provide the location of the position encoding magnet.

In some examples, the data processing circuitry, in determining the location of the position encoding magnet, can be further configured to: generate a vector field representative of the magnetic field propagated by the position encoding magnet, according to the generated signals from the set of magnetic sensing devices, and determine a location of the position encoding magnet according to vector field. Also, it can be can be configured to divide a point of the vector field into at least two vector components pointing in different directions, and determine a location of the position encoding magnet according to vector components of at least one point of the vector field.

Also, the data processing circuitry can also be configured to deactivate output communications from one or more magnetic sensing devices of the set when the magnetic field of the position encoding magnet is not sensed within the magnetic field sensing range of the one or more magnetic sensing devices. It can also be configured to activate output communications from one or more magnetic sensing devices of the set when the magnetic field is sensed within the magnetic field sensing range of the one or more magnetic sensing devices.

The different field components of the magnetic field include differently orientated components can include an axially oriented Z-component and a radially oriented X-component.

Each magnetic sensing device of the set can be multidimensional such that it can sense the different field components of the magnetic field.

Output communications of the set of magnetic sensing devices can include an output signal including contiguous elements corresponding to contiguous magnetic sensing devices of the set of magnetic sensing devices.

Some of the apparatuses can also include a container that includes a straight and/or curved part, such as a straight and/or curved hollowed rod, that at least partially contains the set of magnetic sensing devices. The position encoding magnet can be a ring magnet including a center hole and the container is positioned through the center hole such that the ring magnet can move on the container, such as up and down the container.

Without limitation, one of the purposes of the position sensor described herein is to utilize a set of active or passive sensing elements (e.g., a set of magnetic sensing devices and/or transducers that vary their output signals, such as output voltages, in response to a magnetic field) arranged in a way to acquire differently directed components of a magnetic field of a position encoding magnet, such as a magnetic field generated by an arbitrarily magnetized position encoding magnet. In an embodiment, the position sensor can be or include a linear position sensor. Also, such a sensor can be applicable to a magnet used for determining piston position along a path. The use of more than one field component differently directed provides many advantages. For example, such an arrangement, increases resolution or accuracy of the position sensor, and allows for temperature and magnet degeneration compensation, which in turn allows use of the position sensor with a wide range of applications.

Known systems using a position sensor, such as a linear position sensor, typically use multiple position magnets or do not acquire differently directed components of a magnetic field of a position magnet. One of the advantages of the system described herein is that in some examples one position magnet may be used. Another advantage of the system described herein is that in examples using one position magnet differently, directed components of the magnetic field of the one position magnet can be acquired. In other embodiments of the system, it may be advantageous to use multiple position magnets.

In an embodiment, the system can use more than one magnetic field component by using a set (such as a chain) of sensing elements arranged in a way to acquire differently directed components of a magnetic field for obtaining the position of a position encoding magnet (also referred to herein as a position magnet). The position magnet may include any shape such as a ring, bar, plate, or magnetic tape along a path and can be arbitrarily magnetized such as axial or radial magnetized or a combination of both.

In an example of the system, a beneficial feature may include an optional shutdown of sensing elements that are out of the magnet's range to reduce power intake of the sensor apparatus. This is especially useful in instances where a sensing element of the set delivers a continuous output signal within its sensitive range. Sensing elements that are out of range of the magnet can be turned off by a controller, such as a controlling processing device, to reduce power intake of the sensor apparatus. This can occur because each sensing element can be contiguously aligned with the other sensing elements. Also, the apparatus of the sensing elements can be configured to output a continuous output signal that allows the system to take accurate measurements without using extrapolation.

Another advantage of the system is that a magnet's velocity is not limited by switching speeds of multiplexers or extrapolation calculations, because multiplexers and extrapolation may optionally be avoided. Multiplexers are not needed to implement the sensing elements in the systems. However, multiplexers may be used in some designs.

Another advantage of the system is that it works with various types of magnets, for example, bar magnets and ring magnets. These magnets can sometimes be arbitrarily magnetized such as radially and axially magnetized or a combination of both.

Also, fewer sensing elements can used than in known reed-switch or one-dimensional Hall effect sensor apparatuses. The system also provides for fewer external components to reduce probability of failure and invalid measurements.

Another advantage is improved temperature compensation in temperature sensitive environments. Thermal influences on measurements of a magnetic field can be reduced by using multiple field components instead of multiple additional magnets or sensing devices.

### BRIEF DESCRIPTION OF THE DRAWINGS

FIG. 1 illustrates exemplary operations of exemplary embodiments of the position sensing system.

FIG. 2 illustrates a top view of example aspects of some exemplary embodiments of the position sensing system.

FIGS. 3 and 4 illustrate example graphs showing magnetic field strength of a magnet in some exemplary embodiments of the position sensing system.

FIGS. 5 and 6 illustrate front and side views of two example magnets (a radially magnetized magnet and an axially magnetized magnet), respectively, that can be used with some exemplary embodiments of the position sensing system.

FIGS. 7-10 illustrate additional views of example aspects of some exemplary embodiments of the position sensing system.

FIG. 11 illustrates a perspective view of an exemplary embodiment of a position sensor of some exemplary embodiments of the position sensing system.

FIGS. 12 and 13 illustrate graphs that show example qualitative behavior of sensed magnetic field components of some exemplary embodiments of the position sensing system.

FIGS. 14 and 15 illustrate diagrams of example aspects of some exemplary embodiments of the position sensing system.

### DETAILED DESCRIPTION OF ILLUSTRATIVE EMBODIMENTS

Embodiments of the present disclosure are described more fully hereinafter with reference to the accompanying drawings. Elements that are identified using the same or similar reference characters refer to the same or similar elements. The various embodiments of the present disclosure may, however, be embodied in many different forms and the invention should not be construed as limited to only the embodiments set forth herein.

Specific details are given in the following description to provide a thorough understanding of the embodiments. However, it is understood by those of ordinary skill in the art that the embodiments may be practiced without these specific details. For example, circuits, systems, networks, processes, frames, supports, connectors, motors, processors, and other components may not be shown, or shown in block diagram form in order to not obscure the embodiments in unnecessary detail.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element is referred to as being “connected” or “coupled” to another element, it can be directly connected or coupled to the other element or intervening elements may be present. In contrast, if an element is referred to as being “directly connected” or “directly coupled” to another element, there are no intervening elements present.

It will be understood that, although the terms first, second, etc. may be used herein to describe various elements, these elements should not be limited by these terms. These terms are only used to distinguish one element from another. Thus, a first element could be termed a second element without departing from the teachings of the present disclosure.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

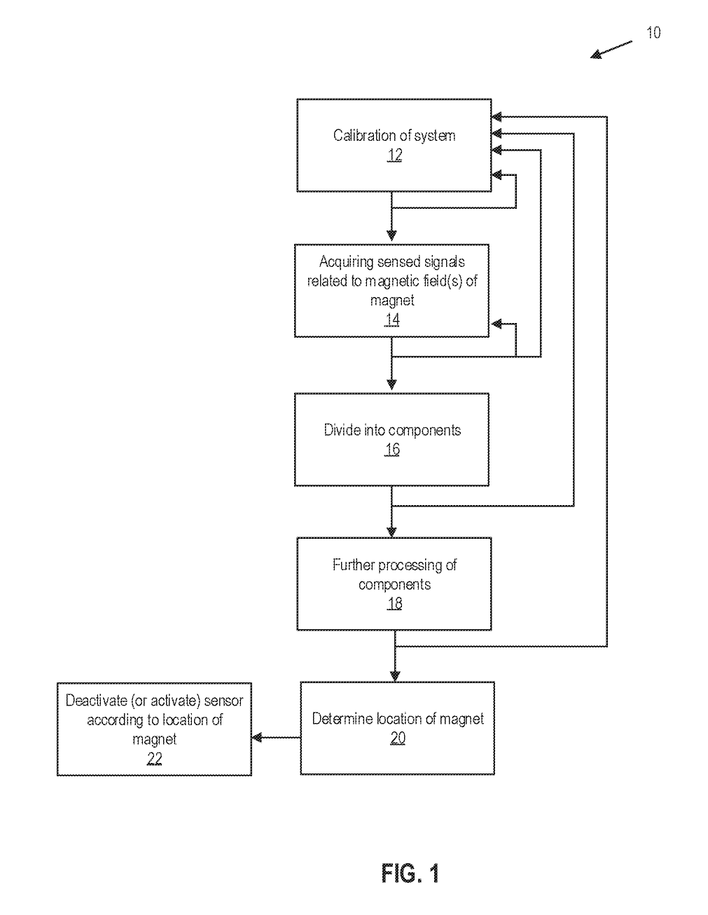

FIG. 1 illustrates operations 10 performed by some exemplary embodiments of the position sensing system. In such embodiments, a magnetic field of a magnet (such as a permanent magnet) can be received by a magnetic field sensor as a vector field at 14 after calibration of the system at 12. With the vector field, the magnet can be used as a position encoder. To enhance the magnet as a position encoder, at one or more selected points of the vector field, the point(s) can be divided into components pointing in different directions at 16. At 18, data related to the magnetic field components determined at 16 can be further processed or fine-tuned. And, such data can be outputted accordingly, such as in the form of graphs. At 20, the output of operations 18 can be used to determine location of the magnet, such as the location at one or more given times. The calibration of the system at operations 12, the acquiring of magnetic fields at operations 14, the data processing at operations 16 and 18, and the determination of the magnet's location at operations 20 can be ongoing and may occur simultaneously.

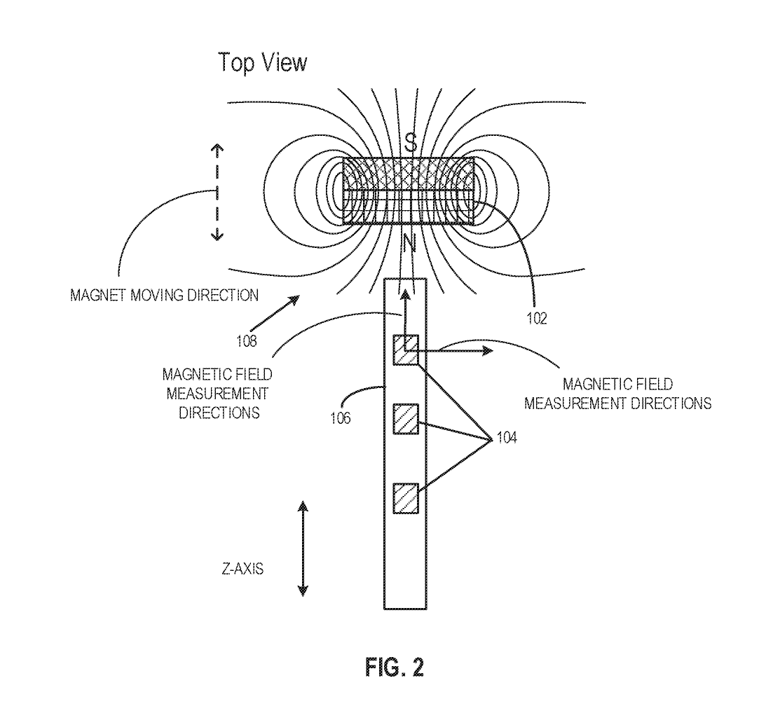

At 16, the processing of a magnetic field point into its components can be done for a plurality of points throughout the vector fields. In an example, acquiring components pointing in different directions from a single point of a vector field is accomplished by arranging a set (such as chain) of sensing elements as shown in FIG. 2. As shown, the arrangement of sensing elements is provided in a way to acquire differently directed components of a magnetic field (such as per selected point of the field). This arrangement is advantageous in that the location of the magnet (which is operating as the position encoder magnet) can be obtained. Acquisition of the points at 14 and their different field components at 16 can be realized by separated and/or multidimensional sensing elements (also referred to herein as the sensing elements).

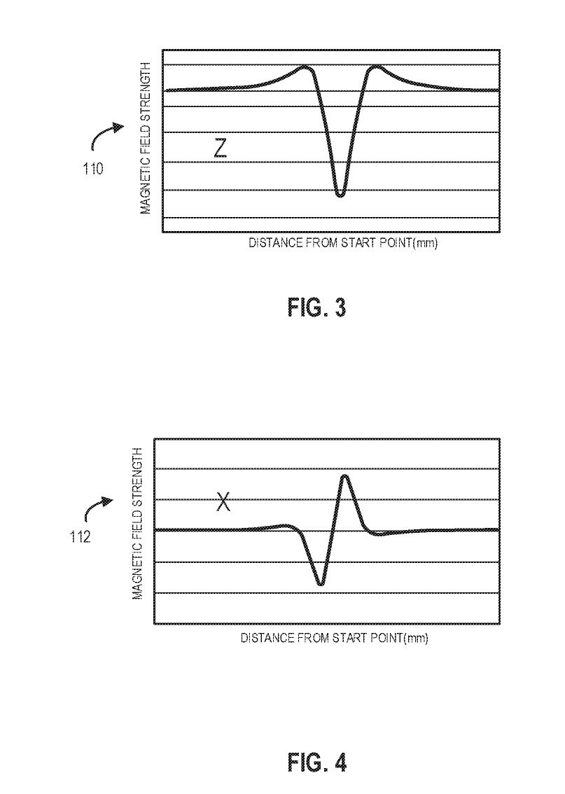

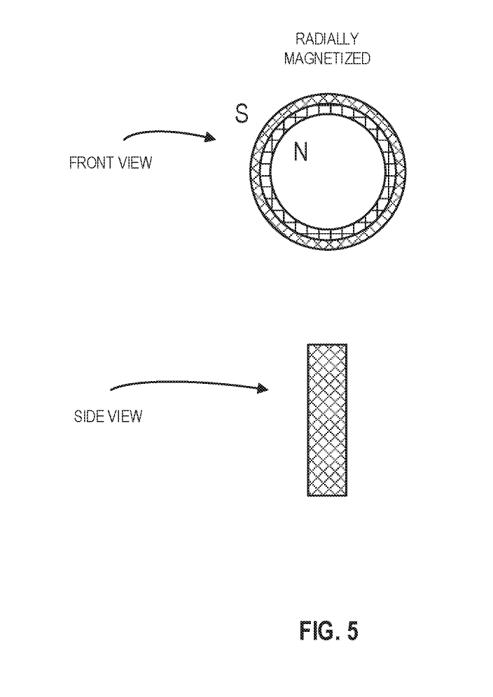

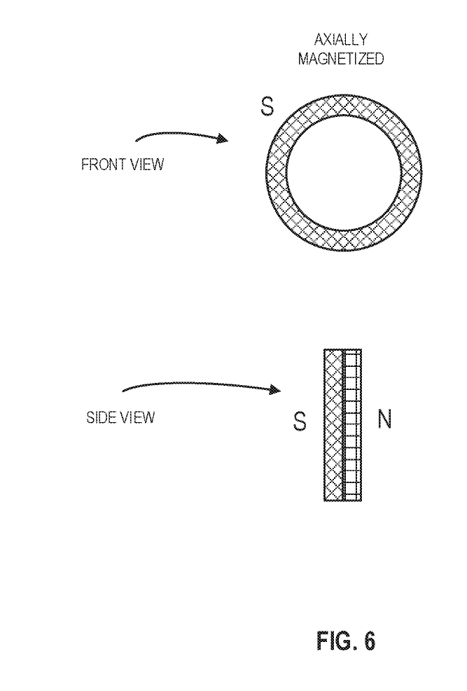

FIG. 2 illustrates a top view of the magnet 102 and sensing elements 104 arranged on structure 106. In this example, the sensing elements are Hall effect sensing elements that can sense the magnetic field 108. FIGS. 3 and 4 depict graph 110 and graph 112 respectively, each showing magnetic field strength of the magnet 102 in two different directions, direction Z and direction X, respectively. These graphs are plotted with respect to distance from a starting point of the movement of the magnet 102. As depicted, the magnet 102 moves up and down along a Z-axis.

Also, the graphs 110 and 112 represent a field strength to position on the magnet 102 for respective magnetic field directions Z and X. These graphs 110 and 112 (or associated data), solely or combined, can provide a magnetic field profile for the magnet 102. A respective magnetic field profile of a magnet can be discoverable through experimentation and may change over time (and in real time in some examples) and be unique with respect to other magnets. Also, a magnetic pole orientation of a magnet may be discoverable by a respective profile.

Further, a magnetic field profile, as described herein, can be used as a basis to determine location of the magnet at 20. The system can compare the profiles against a current reading of the magnetic field to determine precise locations of the magnet. Using such a technique, profiles containing information on multiple magnetic field directions should be more precise than those only using one direction.

The sensing elements can be used with a radially or axially magnetized ring magnet (as shown in FIG. 2) or with a bar magnet or with any other magnet and magnetization. As shown in FIG. 2, magnet 102 is axially magnetized.

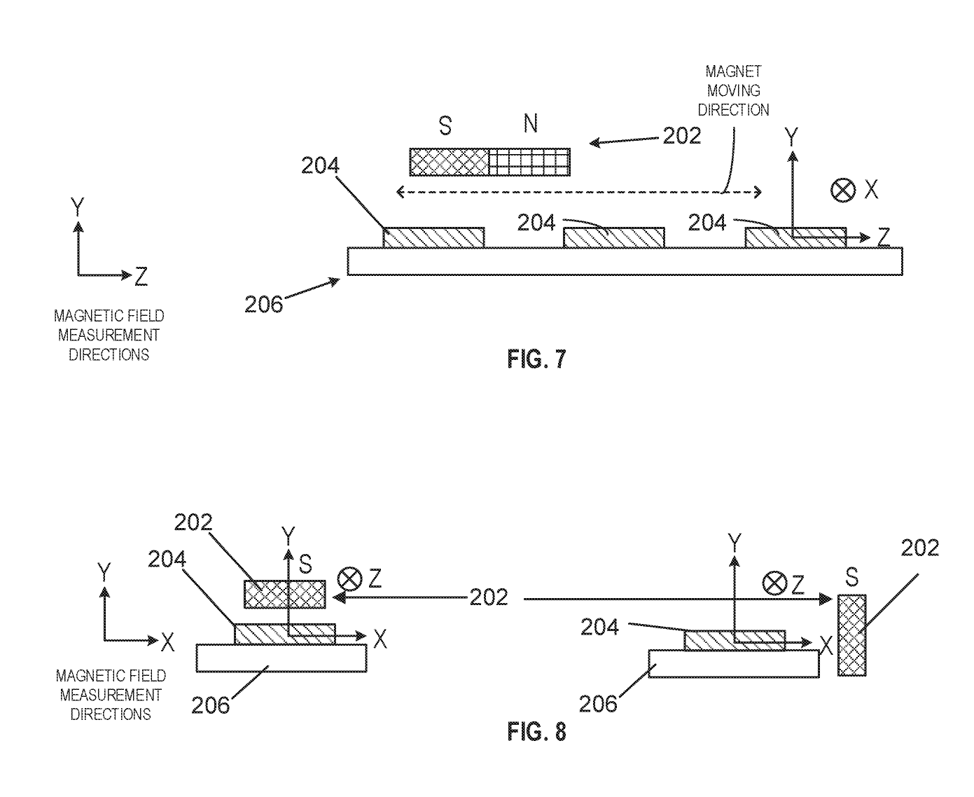

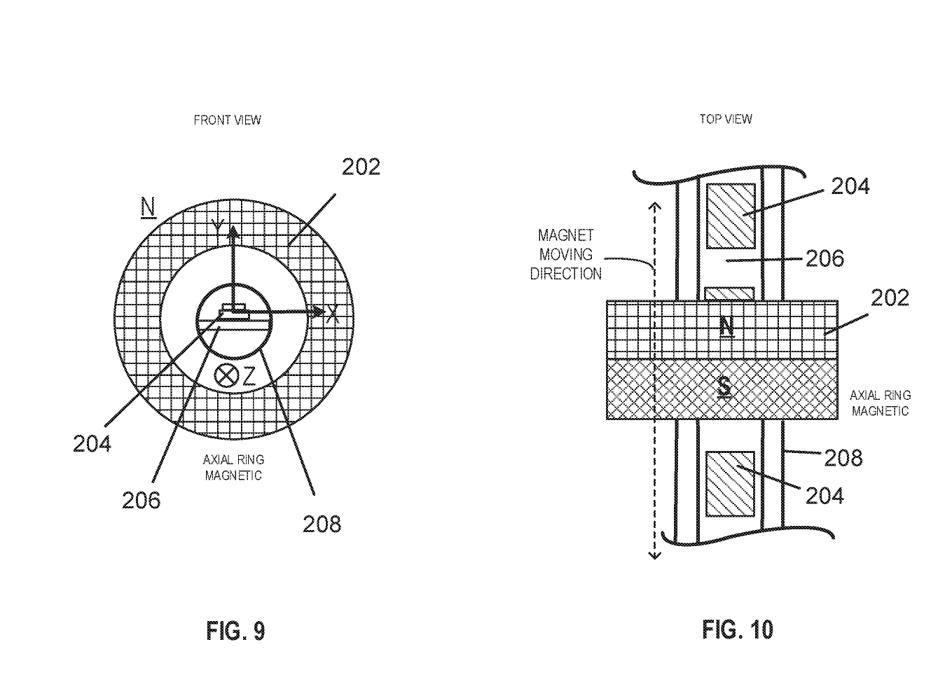

As shown in FIGS. 9 and 10, a magnet can be arranged around the set of sensing elements. As shown in FIGS. 7 and 8, the magnet 202 can be arranged besides or around the set of sensing elements. As shown by FIG. 8, the magnet 202 is moving in and out of the drawing on the Z-axis. The magnet is moving left and right on the Z-axis in FIG. 7. As shown in the front view of FIG. 9, the magnet is moving in and out of the drawing on the Z-axis. Each of these magnetic configurations also can have field strength to position graphs similar to graphs 110 and 112. The magnetic field strength to position of the magnet can vary in a known relationship and the shape of the graphs may be different per magnet. Also, each magnetic pole orientation may have advantageous characteristic(s).

Note that FIGS. 9 and 10 schematically illustrate front and top views of magnet 202 respectively. As shown, magnet 202 is an axially magnetized ring magnet. In FIGS. 9 and 10, magnet 202 is positioned beside Hall effect sensor element 204, printed circuit board (PCB) 206, and sensor container 208. As shown, Hall effect sensing elements, such as element 204, are attached to PCB 206 that is attached within sensor container 208.

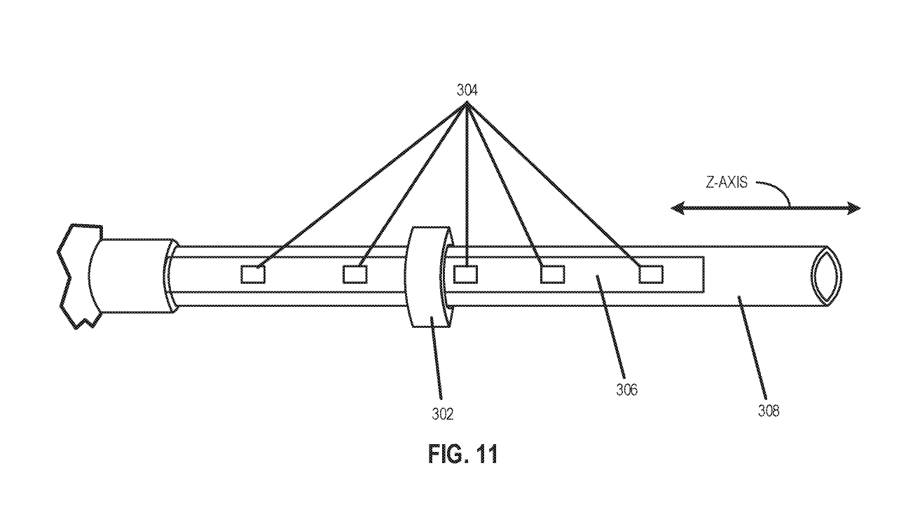

As shown by FIG. 11, a ring magnet 302 can move along the Z-axis. Also, as shown in FIG. 11, the structure of a ring magnet 302 can encircle the sensor container 308 (which in this instance includes a straight hollowed rod). Note that the container can be any shape providing a path for the sensing elements. Also, the shown cross-section of the container 208 in FIG. 9 is circular, but a cross section of other containers for the system and a corresponding magnet aperture can take any complementary form, such as a rectangular form.

The apparatus described herein can be arranged in a way that symmetries can be used. For example, as shown in FIG. 11, the sensing elements 304 can be located proximate to a middle axis of a ring magnet 302. A sensor container 308, enclosing the PCB 306 holding the sensor elements 304, can be positioned through a ring magnet 302, such that the sensing elements can be located proximate to a middle axis of the ring magnet. This is also shown in FIGS. 9 and 10.

In an example of the system, the sensors that may vary in their sensing capabilities may be configured to acquire field components from further away. Such variations or configurations may provide for a reduced number of sensing elements needed to determine a position of the position magnet. For instance, each sensing element covers a certain range and the certain range can be configured to be larger. Thus, less sensing elements are needed. However, there may be a tradeoff in accuracy with less sensing elements in the set. Also, the range each sensing element is configured to cover can be limited by the extent of the magnetic field. The extent of the field can be influenced by the surrounding material and the geometric properties of the surrounding material. In consideration of this influence the sensing elements can be configured accordingly.

Alternatively, or in addition to the aforementioned example, instead of reducing the number of sensing elements, an example of the system may include a greater number of sensing elements to enhance accuracy. Where a greater number of sensing elements are used, the sensing capabilities of each element may be configured to acquire field components from a lesser distance. Also, such a variation may provide for use of less expensive sensing elements, since each element is configured to cover a shorter range.

Referring back to FIG. 2, shown are radially and axially oriented components of the magnetic field the magnetic field 108 with respect to the moving direction of ring magnet 102, and an arrangement of the sensing elements 104 that can capture the two shown field components. FIG. 2 shows a schematic illustration of such a setup and FIG. 11 shows a perspective view of the arrangement. In both drawings, it is also shown that the magnet 102 can move along the Z-axis.

In the arrangements illustrated herein, each sensing element can include a two-dimensional sensing element or even a three-dimensional sensing element. In instances using a two-dimensional sensing element, the sensing element can be used to detect two field components. For example, the sensing element can detect an axially oriented Z-component and a radially oriented X-component.

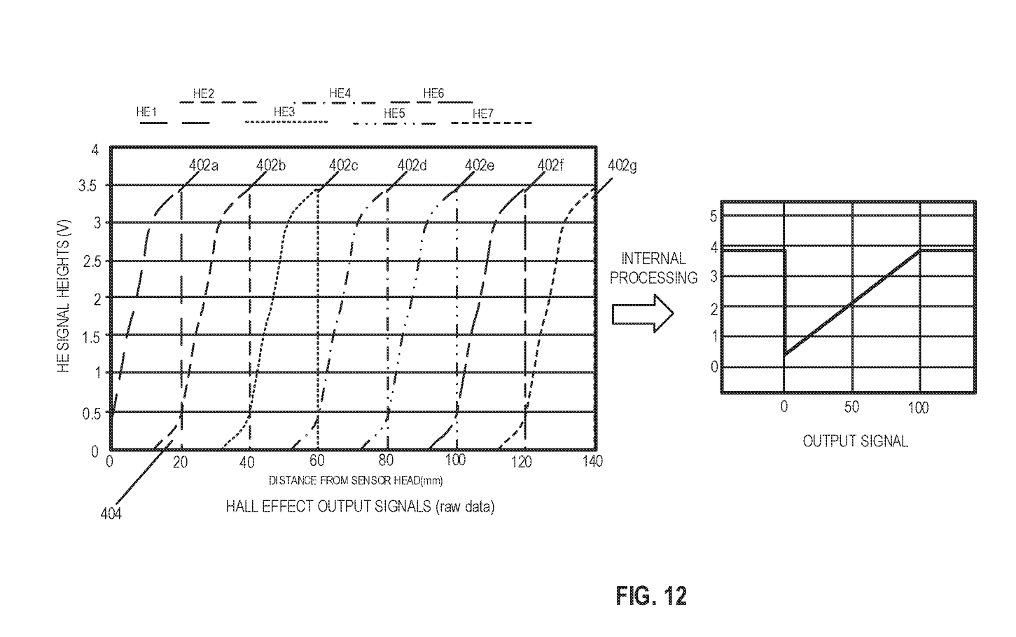

FIG. 12 illustrates graphs that show the qualitative behavior of multiple magnetic field components that can be the outputs of operations 18 and their effect on each sensing range of the set of sensing elements. Also, profiles of such graphs can be used to calibrate the system at 12. In some examples, the sensor apparatus can be calibrated to a certain magnet and to a certain application as the magnetic field is directly measured at operations 14 or 16 depending on the embodiment. At 12 in FIG. 1, shown is calibration of the system. Such simultaneous calibration can improve performance and make the sensors more versatile to work in a wide range of applications. This type of calibration at 12 can occur because of continuous updating of magnetic field strength with respect to the sensitive regions of the sensing elements during acquiring of the magnetic fields and their components at operations 14 and/or 16.

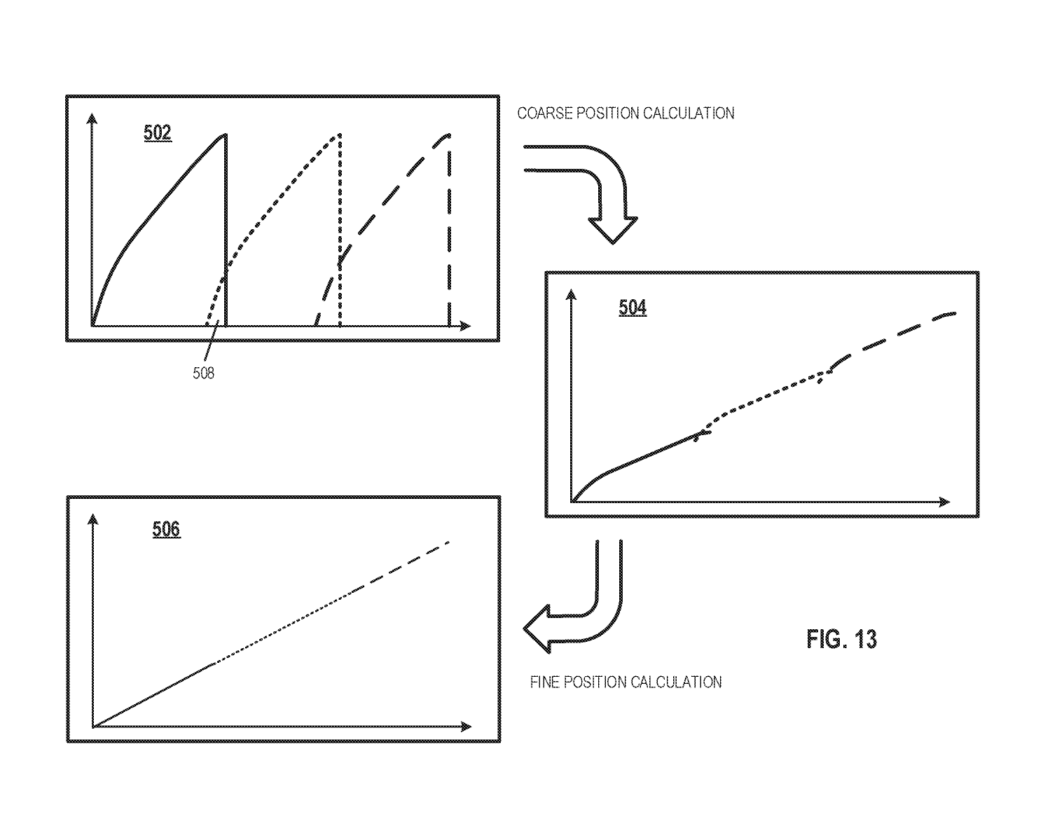

The left graph of FIG. 12 shows respective graphical pulses 402a-402g, which may be analog signals, such as analog voltage signals, representative of respective magnetic field sensing ranges of seven serially aligned sensing elements. Similarly, graph 502 of FIG. 13 shows three graphical pulses representative of respective magnetic field sensing ranges of three serially aligned sensing elements. Between two adjacent sensing elements, as shown by the pulses, a hand-over zone is defined, such a zone 404 in FIG. 12 or 508 in FIG. 13. The hand-over zone 404 includes overlap of the sensitive ranges represented by pulses 402a and 402b. Thus, hand-over zones corresponding to pulses 402a-402g combined with the pulses 402a-402g can be a part of or associated with an overall output signal of the set of sensing elements. This overall output signal can include, as shown in FIG. 12, contiguous signal elements corresponding to the sensing elements of the set. In an example, the sensing elements may be contiguous as well.

From the raw data illustrated in the left graph of FIG. 12, with subsequent signal processing of the acquired field components from each of the sensing elements using operations 18, a processor of the system can derive and output a unique and contiguous magnet position within each element's sensitive range, such as the output signal illustrated in the right graph of FIG. 12.

Similarly, as shown in FIG. 13, the individual outputs of the hall elements 502 are aggregated by data processing circuitry, such as a processor, and such as by using offsets, to generate a graph showing a coarse position of the position magnet 504. The coarse position graph 504 and an internal representation of the magnetic field, such as an internal representation stored in memory coupled to the processing circuitry, is used to calculate the fine position graph 506. Each of these graphs shown in FIGS. 12-13 may be the output of operations 18.

The internal representation of the magnetic field may be digitized raw signals (originally raw analog signals) stored in processing circuitry and/or memory during calibration. Use of the internal representation of the magnetic field can lead to a non-linearized sectionally defined output signal shown by graph 504. This last mentioned output can then be linearized to generate graph 506.

There are many other approaches that could be used to fine tune the location detection of the position magnet. For example, the linearization could happen directly on the sensing elements, if the shape of the magnetic field is known. In such an example, digitizing and storing the raw signals external to the sensing elements would be unnecessary; since such processing could be done by the sensing elements. Another option is to describe the magnetic field's characteristics with a mathematic function, which must be tailored according to the application. In one example, a spline representation of the magnetic field is used, such that the field can be represented by a function that has specified values at a finite number of points and consists of segments of polynomial functions joined smoothly at these points, enabling it to be used for approximations.

Referring to FIG. 12, the right graph labeled “output signal” shows a linearized output of a unique and contiguous magnet position according to each element's sensitive range. From this output the position of the position magnet can be determined.

Based on the output signal derived from the raw data, after internal processing with handover, sensing elements can be optionally switched off. For example, a standby mode (such as a lower power consumption mode) or complete turning off of a sensing element can occur at 22 according to the determination of the location of the magnet at 20. The output signal of operations 20 can also include an indication of whether the magnet is out of range as well. Where the magnet is in range, the corresponding sensing elements are actively communicating to a data processing unit at operations 14 and/or 16 depending on the implementation of the system. Otherwise communications can be turned off at 22. This can reduce the sensor apparatus's power usage.

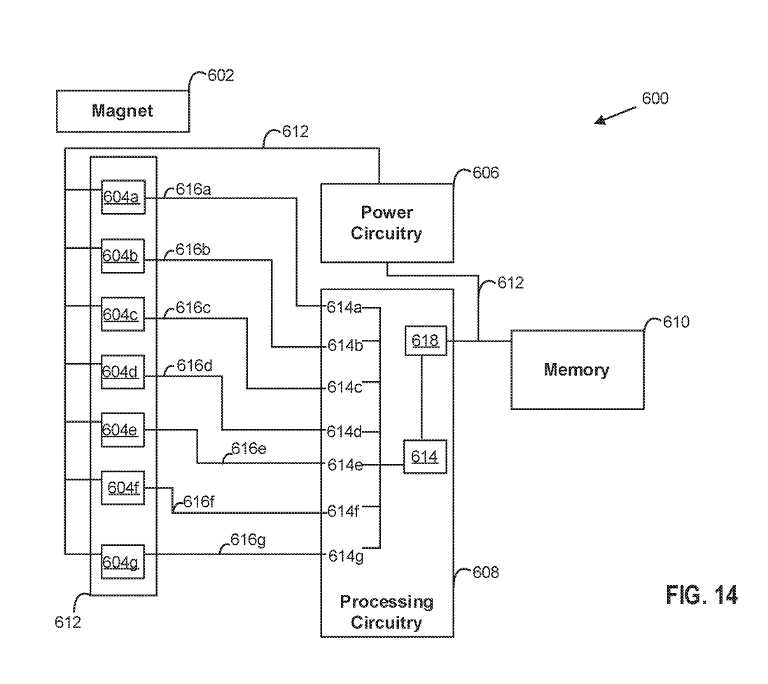

FIG. 14 illustrates a schematic diagram of example aspects of an exemplary embodiment 600 of the position sensing system. The embodiment 600 can include sensing elements 604a-604g (which can perform sensing and acquiring of magnetic field data included in operations 10 of FIG. 1), position magnet(s) 602 (which can implement operations of the magnetics in operations 10), power circuitry 606 (which can perform power management operations included in operations 10), signal processing circuitry 608 (which can perform data processing operations included in operations 10), memory 610 (which can implement storage operations in and related to operations 10), and an electrical communication bus 612 that connects at least the sensing elements, the power circuitry, the signal processing circuitry, and the memory. The position magnet(s) 602 may include one or more of any type of encoding magnets of any shape such as a ring, bar, plate, magnetic tape, or the like.

The sensing elements 604a-604g may include analog Hall sensors (such as programmable Hall-effect sensors for rotational or linear position detection), reed switches, magneto-resistive based sensors, fluxgate magnetometers, the like, or any combination thereof. In an example where analog Hall sensors are used, each of the sensing elements 604a-604g may measure two or more directional components of a magnetic field of the magnet(s) 602 and run an internal calculation with the components, such as arctangent of the first directional component divided by the second directional component (arctangent[first component/second component]), so that there is one output signal from each Hall sensor, such as the outputs shown in FIGS. 12 and 13. In such an example, the two or more directional components may include Z and X components of the magnetic field of an axially magnetized ring magnet, such as the components shown in graphs 110 and 112.

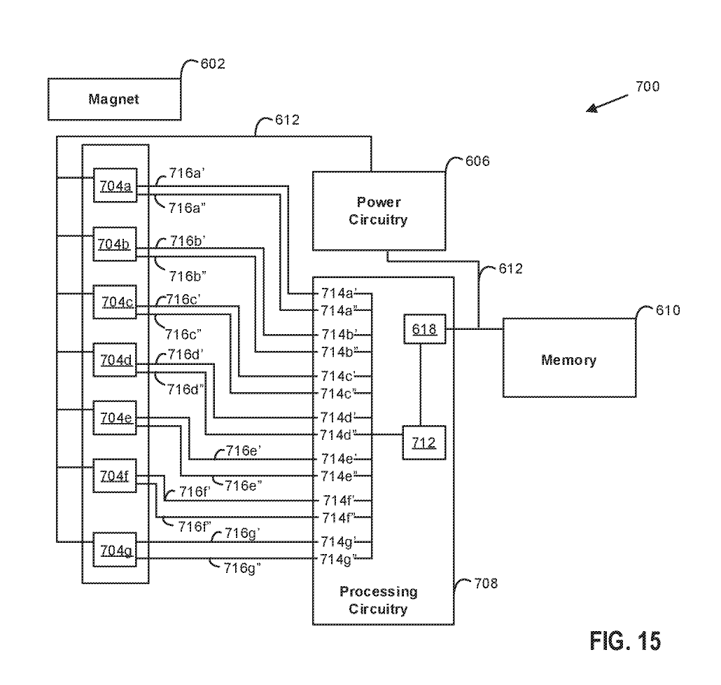

Alternatively, each sensing element of the system, can output the two directional components and processing circuitry external to the sensing elements can run the internal calculation with the components (such as illustrated by exemplary embodiment 700 in FIG. 15). In other words, the sensing elements could include sensors that include at least two independent outputs corresponding to different directional components of a magnetic field. However, in such examples, more robust processing circuitry external the sensing elements may be needed. Alternatively, the sensing elements may include a digital output that can transmit multiple field components independently via a serial peripheral interface bus.

The power circuitry 606 may include a portable or non-portable power source, such as a battery pack, a transformer, or the like. The power circuitry 606 can provide power for the computations by the processing circuitry 608, various communications between the aspects of FIG. 14 and other aspects described herein, and for the activation of the sensing elements 604a-604g if the sensing elements are active sensors. Also, in some examples the magnetic field of the position magnet(s) 602 can be produced by electrical energy supplied by the power circuitry 606.

The output signals of all sensing elements, including sensing elements 604a-604g, can be communicated to and/or read by processing circuitry 608, serially or simultaneously over the bus 612, in an example. The processing circuitry 608 can be embodied in digital and/or analog electronic circuitry, on circuit boards and/or system-on-a-chip (SoC) (where a microchip with all the necessary electronic circuits and parts exist for an embodiment of the system). Other suitable technologies for processing circuitry 608 include a microcontroller, a FPGA, a CPLD, an ASIC, or the like. If the sensor apparatus of elements 604a-604g is calibrated to a certain magnet and application, the individual signals from the sensing elements can be calculated and linearized to derive precise position information of the magnet.

The memory 610, which can include random access memory (RAM) and/or read-only memory (ROM), can be enabled by memory devices. The RAM can store data and instructions defining an operating system, data storage, and applications for processing the data described herein. In an example embodiment, wherein the processing circuitry 608 is a processing unit, instructions stored in the memory can be executed by the processing unit to perform the various automation and data and signal processing described herein. The ROM can include basic input/output system (BIOS) of the embodiment 600.

Also, the memory 610 may include any sort of non-transitory medium executable by a processor, such as the processing circuitry 608. For example, the memory 610 can include a non-transitory medium with instruction executable by a processor to cause the processor to perform any of the operations described herein.

As shown, the processing circuitry 608 includes input components 614a-614g corresponding to outputs 616a-616g of the sensing elements 604a-604g. The processing circuitry 608 can also include output component 618, which provides the linearized output of a unique and contiguous magnet position according to each element's sensitive range, such as shown by the right graph of FIG. 12. From the output component 618 the position of the magnet(s) 602 can be determined. Further, the output component 618 can be derived by data processing component 614. The data processing component 614 can derive the determination of the location of the position encoding magnet according to the signals generated by the sensing elements 604a-604g, by aggregating the multicomponent-based signals of the set of sensing elements into one signal and linearizing the one aggregated signal to provide the location of the position encoding magnet.

An output component of output components 616a-616g and a corresponding input component of input components 614a-614g provide a channel for a signal representative of a sensed magnetic field strength of the magnet(s) 602 in a first direction and a second direction. For example, the output components 616a-616g may correspond to graphical pulses 402a-402g illustrated in FIG. 12, where the pulses illustrated in FIG. 12 are representative of instances of a first or second direction of the magnetic field of the magnet(s) 602 sensed by the sensing elements 604a-604g.

FIG. 15 illustrates a schematic diagram of example aspects of an exemplary embodiment 700 of the position sensing system. An alternative to the embodiment 600 illustrated in FIG. 14, the embodiment 700 includes processing circuitry 708 (which can perform data processing operations included in operations 10 of FIG. 1) and sensing elements 704a-704g (which can perform sensing and acquiring of magnetic field data included in operations 10). The processing circuitry 708 includes data processing component 712 that can run an internal calculation with different directional components of a magnetic field to output one signal representative of the magnetic field strength. The sensing elements 704a-704g may include Hall sensors, reed switches, magneto-resistive based sensors, fluxgate magnetometers, the like, or any combination thereof.

As shown, the processing circuitry 708 includes input components 714a′-714g′ and 714a″-714g″ corresponding to outputs 716a′-716g′ and 716a″-716g″ of the sensing elements 704a-704g. The processing circuitry 708 can also include output component 618, which provides the linearized output of a unique and contiguous magnet position according to each element's sensitive range, such as shown by the right graph of FIG. 12. From the output component 618 the position of the magnet(s) 602 can be determined. Further, the output component 618 can be derived by data processing component 712. The data processing component 712 can derive the determination of the location of the position encoding magnet according to the signals generated by the sensing elements 604a-604g, by using a calculation, such as an arctangent calculation, to generate a multicomponent-based signal representative of different field components of a magnetic field, such as per sensing element of the set of sensing elements, aggregating the multicomponent-based signals of the set of sensing elements into one signal, and linearizing the one aggregated signal to provide the location of the position encoding magnet.

An output component of output components 716a′-716g′ and a corresponding input component of input components 714a′-714g′ provide a channel for a signal representative of a sensed magnetic field strength of the magnet(s) 602 in a first direction. The sensed magnetic field is sensed by a corresponding sensing element of the sensing elements 704a-704g. Likewise, an output component of output components 716a″-716g″ and a corresponding input component of input components 714a″-714g″ provide a channel for a signal representative of a sensed magnetic field strength of the magnet(s) 602 in a second direction—which is sensed by the corresponding sensing element. For example, one of the output components of output components 716a′-716g′ and 716a″-716g″ may output data similar to the data illustrated in graph 110 or graph 112 of FIGS. 3 and 4 respectively.

From the output components 716a′-716g′ and 716a″-716g″, via inputs 714a′-7164′ and 714a″-714g″, the data processing component 712 can run internal calculations with the components. As mentioned, for instance, the data processing component 712 can run an arctangent function on the first directional component divided by the second directional component (arctangent[first component/second component]) per inputs 714a′-7164′ and 714a″-714g″, so that there is one output signal representative of each sensing element 704a-704g, as shown in FIGS. 12 and 13. In such an example, the two or more directional components may include Z and X components of the magnetic field of an axially magnetized ring magnet, such as the components shown in graphs 110 and 112.

Similar to the example in FIG. 14, the embodiment 700 can include position magnet(s) 602, power circuitry 606, memory 610, and an electrical communication bus 612 that connects at least the sensing elements 704a-704g, the power circuitry, the signal processing circuitry 708, and the memory. Also, the power circuitry 606 can provide power for the computations by the processing circuitry 708, various communications between the aspects of FIG. 15 and other aspects described herein, and for the activation of the sensing elements 704a-704g if the sensing elements are active sensors. Further, the output signals of all sensing elements, including sensing elements 704a-704g, can be communicated to and/or read by processing circuitry 708, serially or simultaneously over the bus 612. Similarly, the processing circuitry 708 can be embodied in digital and/or analog electronic circuitry, on circuit boards and/or system-on-a-chip (SoC) (where a microchip with all the necessary electronic circuits and parts exist for an embodiment of the system). Other suitable technologies for processing circuitry 708 include a microcontroller, a FPGA, a CPLD, an ASIC, or the like. If the sensor apparatus of elements 704a-704g is calibrated to a certain magnet and application, the individual signals from the sensing elements can be calculated and linearized to derive precise position information of the magnet. Also, in an example embodiment, wherein the processing circuitry 708 is a processing unit, instructions stored in the memory can be executed by the processing unit to perform the various automation and data and signal processing described herein.

It is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “connected,” “coupled” and variations thereof are used broadly and encompass both direct and indirect connections and couplings. Further, “connected” and “coupled” are not restricted to physical or mechanical connections or couplings.

Although the present invention has been described with reference to preferred embodiments, workers skilled in the art will recognize that changes may be made in form and detail without departing from the spirit and scope of the invention.

1. A method, comprising:
detecting, by a set of sensing elements, different field components of a magnetic field of a position encoding magnet;
generating, with data processing circuitry, signals associated with the set of sensing elements, the generated signals including the different field components; and
determining with the data processing circuitry a location of the position encoding magnet according to the generated signals, using a calculation to generate a multicomponent-based signal representative of the different field components.

2. The method of claim 1, wherein the determining of the location of the position encoding magnet further includes:
generating a vector field representative of the magnetic field, according to the generated signals; and
determining the location of the position encoding magnet according to the vector field.

3. The method of claim 2, wherein the determining of the location of the position encoding magnet further includes:
dividing each point of the vector field into vector components corresponding to the different field components; and
determining the location of the position encoding magnet according to the vector components.

4. The method of claim 1, wherein the determining of the location of the position encoding magnet according to the generated signals includes using an arctangent calculation to generate the multicomponent-based signal representative of the different field components.

5. The method of claim 1, wherein the using of the calculation to generate the multicomponent-based signal representative of the different field components occurs for each sensing element of the set of sensing elements individually.

6. The method of claim 1, wherein the determining of the location of the position encoding magnet according to the generated signals includes aggregating the multicomponent-based signals of the set of sensing elements into an aggregated signal.

7. The method of claim 6, wherein the determining of the location of the position encoding magnet according to the generated signals includes linearizing the aggregated signal to provide the location of the position encoding magnet.

8. The method of claim 1, wherein different field components of the magnetic field include differently orientated components.

9. The method of claim 8, wherein the different field components include an axially oriented Z-component.

10. The method of claim 8, wherein the different field components include a radially oriented X-component.

11. The method of claim 1, wherein each sensing element of the set of sensing elements is multidimensional such that it can sense the different field components of the magnetic field.

12. The method of claim 1, wherein each sensing element of the set of sensing elements includes either a Hall effect sensor, a magneto-resistive based sensor, a reed switch, or a fluxgate magnetometer.

13. The method of claim 1, further comprising deactivating output communications from one or more sensing elements of the set of sensing elements when the magnetic field is not sensed within the magnetic field sensing range of the one or more sensing elements, by limiting or shutting off power to the one or more sensing elements.

14. The method of claim 1, further comprising activating output communications from one or more sensing elements of the set of sensing elements when the magnetic field is sensed within the magnetic field sensing range of the one or more sensing elements.

15. The method of claim 1, wherein the set of sensing elements includes sensing elements in series, wherein each respective magnetic field sensing range of each sensing element of the set that are in series overlaps with at least one respective magnetic field sensing range of an immediate neighboring sensing element in the set, such that extrapolation is not required to determine the location of the position encoding magnet.

16. An apparatus, including:
a position encoding magnet;
a set of magnetic sensing devices, each magnetic sensing device of the set configured to vary its output signal in response to a magnetic field propagated by the position encoding magnet; and
data processing circuitry configured to determine and output a location of the position encoding magnet, according to signals generated from the set of magnetic sensing devices,
wherein the generated signals include signals indicative of different field components of the magnetic field of the position encoding magnet, and
wherein a calculation is used by the data processing circuitry to create a multicomponent-based signal representative of the different field components based on the generated signals.

17. The apparatus of claim 16, wherein different field components of the magnetic field include differently orientated components including an axially oriented Z-component and a radially oriented X-component.

18. The apparatus of claim 16, wherein each magnetic sensing device of the set is multidimensional such that it can sense the different field components of the magnetic field.

19. The apparatus of claim 16, wherein the data processing circuitry is configured to:
deactivate output communications from one or more magnetic sensing devices of the set when the magnetic field of the position encoding magnet is not sensed within the magnetic field sensing range of the one or more magnetic sensing devices; and
activate output communications from one or more magnetic sensing devices of the set when the magnetic field is sensed within the magnetic field sensing range of the one or more magnetic sensing devices.

20. The apparatus of claim 16, further comprising a container that includes a straight or curved part that at least partially contains the set of magnetic sensing devices, wherein the position encoding magnet is a ring magnet including a center hole and the container is positioned through the center hole such that the ring magnet can move on the container.
